(19) United States
(12) Patent Application Publication
(10) Pub. No.: US 2011/0041704 A1
(43) Pub. Date: Feb. 24, 2011

(54) DEVICE FOR STIRRING, FROTHING AND OPTIONALLY HEATING LIQUID FOODS

(75) Inventor: Georg Feierabend, Aarburg (CH)

Correspondence Address: RANKIN, HILL & CLARK LLP, 38210 GLENN AVENUE, WILLOUGHBY, OH, 44094-7808, US

(73) Assignee: DOMO VISION AG, Oftringen (CH)

(21) Appl. No.: 12/866,580

(22) PCT Filed: Feb. 5, 2009
(86) PCT No.: PCT/CH09/00046

§ 371 Date: Nov. 4, 2010

(30) Foreign Application Priority Data
Feb. 8, 2008 (CH) 180/08

(51) Int. Cl. A47J 43/046; A47J 31/00; B65D 25/00

(52) U.S. Cl. 99/323.1; 220/694

(57) ABSTRACT

A device for stirring, frothing and optionally heating liquid foods, particularly for frothing milk, including at least two device parts: First, a freely movable fluid container, which has no electric machine parts and is therefore waterproof and dishwasher-safe, and secondly, a machine part, into the housing of which a motor for a driving magnet and further machine parts, such as a heater and a temperature sensor, can be installed.

### BACKGROUND OF THE INVENTION

1. Field of the Invention

The subject matter of the present invention is a device according to the preamble of the first independent patent claim. The device serves for stirring, frothing and optionally heating liquid foods, in particular for frothing milk.

2. Description of Related Art

A known device of the type referred to, which is commercially available and is described in EP 1,827,188 is, for example, the Nespresso Aeroccino milk frother. Said device has a liquid space, into the base or wall of which a magnetic stirring mechanism and an electric heater are fitted. The magnetic stirring mechanism has a rotatingly driven driving magnet which drives a magnetic stirrer which can be placed onto a spike in the liquid space. The device is furthermore equipped with a temperature sensor via which the heater is switched off at a liquid temperature of, for example, 70° C.

Such devices which are known from the prior art for stirring, frothing and optionally heating liquid foods can be cleaned only relatively poorly. This is true in particular of the movable liquid container which, because of the electric components integrated therein, must not be submerged in water and must not be washed at all in a dishwasher. This is a disadvantage and hygienically unsatisfactory, in particular for the removal of adhering milk residues or those which have been burnt on. In addition, the known devices are restricted to only one maximum liquid volume.

The present invention has the object of providing a device which is suitable for stirring, frothing and optionally heating liquid foods, in particular for frothing milk, wherein the device is intended to be simpler with regard to cleaning than the known devices mentioned above.

### BRIEF SUMMARY OF THE INVENTION

The device according to the invention for stirring, frothing and optionally heating liquid foods has a machine part and a liquid container which is freely movable independently of the machine part and does not have any electric components (components through which electric currents are conducted in a specific manner upon connection to a power source), wherein the two parts are matched to each other in such a manner that the liquid container can be placed onto the machine part serving as a base. A magnetic stirrer can be positioned in the liquid container. The liquid container with or without the magnetic stirrer in position can be submerged without problem into rinsing water for cleaning purposes or can be washed in a dishwasher. The machine part has the magnetic stirring mechanism and optionally the heater, temperature sensor, timer and other control elements, and a supporting surface for the liquid container, wherein, for example, the upper side of a housing can be designed as the supporting surface. In preferred embodiments, the rotating driving magnet projects out of said supporting surface, advantageously covered by a corresponding bulge in the supporting surface, and the base of the liquid container has a corresponding indentation in the form of a structure which is permanently present in the liquid space and on which the magnetic stirrer is rotatably mounted, for example can be placed thereon. The structure for the rotatable mounting of the magnetic stirrer, and the magnetic stirrer are preferably designed in such a manner that the magnetic stirrer remains fastened on the structure even without the action of the magnetic attracting force of the driving magnet, and therefore the magnetic stirrer does not drop out of the liquid container when the liquid is being poured out.

In other preferred embodiments, the magnetic stirrer is fastened in a freely rotatable manner on a structure which can be reversibly brought into the liquid space and which serves as a holding means for the magnetic stirrer and is designed, for example, as a holding bar. A magnetic-stirrer holding bar of this type can be, for example, fitted into the liquid space from above and can be pulled out again. In this case, the magnetic stirrer is positioned over the driving magnet in the liquid container, which is placed onto the machine part, in such a manner that the magnetic driving force can be transmitted from the driving magnet of the machine part to the magnetic stirrer in the liquid container. In advantageous embodiments, the upper end of the holding bar is fastened to a cover matching the liquid container. In embodiments without a cover, the holding means for the magnetic stirrer can be fastened, for example, to the upper edge of the liquid container.

Embodiments of this type with a structure which can be reversibly brought into the liquid container in order to receive the magnetic stirrer, therefore do not require any permanent structures for receiving the magnetic stirrer on the inner surface of the liquid container. Therefore, in particular, the inner base surface of the liquid container can be of a flat design and the supporting surface of the machine part can also be of a substantially flat design, since the rotating driving magnet does not project out of the supporting surface. Preferred embodiments of the supporting surface of said embodiments and of the outer surface of the base of the liquid container are equipped with structures, such as tongue and groove, or other corresponding projections and depressions or structures similar to quarter-turn fasteners for the precisely matching positioning of the liquid container on the supporting surface of the machine part. In some embodiments, precise positioning is very important because the magnetic stirrer is not positioned over the center of the base surface of the liquid container, but rather is positioned eccentrically in order to obtain optimum generation of foam.

A particular advantage of the embodiments without permanent structures for holding and rotatably mounting the magnetic stirrer on the inner surface is in particular a flat, inner base surface of the liquid container such that the liquid container can be cleaned in a very particularly simple manner. A further advantage of embodiments of this type with a magnetic-stirrer holding means which can be reversibly brought into the liquid space is that the magnetic stirrer, because of being fastened to the holding means, can readily be removed from the liquid container prior to the liquid being poured out and does not undesirably drop out when the liquid is being poured out.

If the holding means, for example the holding bar, of the magnetic stirrer is fastened to the cover of the liquid container, the cover is opened and the magnetic stirrer removed in one hand movement. The holding bar is preferably fastened reversibly to the cover and the magnetic stirrer is preferably fastened reversibly to the holding bar for removal for cleaning purposes and space-saving storage. Furthermore, a reversible fastening of the magnetic stirrer to the holding means also ensures a choice of different types of magnetic stirrers depending on the application (stirring of cream, or sauce or frothing of milk or hot chocolate, etc.), for example in embodiments using coils or blades made of a suitable metal or plastic.

A structure mounted permanently in the liquid container or a structure which can be reversibly brought into the liquid container for the rotatable fastening of the magnetic stirrer can be arranged either in the center of the liquid container, i.e. in coordination with the center axis thereof, or eccentrically. An eccentric arrangement promotes the formation of froth, for example when frothing milk.

The great advantage of the device according to the invention over the known devices is the physical division of the function of receiving the liquid, on the one hand, and all of the electric functions on the other hand, between two separate device parts. Said device parts are separated from each other in such a manner that the lower machine part in the form of a base at the same time takes on a stand function and the liquid container which can be placed onto said base is designed as a movable part, i.e. for example, has a handle, and is also suitable for pouring out the stirred and/or frothed food and at the same time is easy to clean. In preferred embodiments, the machine part serving as the base does not project substantially over the normal level of the liquid container, for example an optionally insulating positioning structure, which may project over the normal level of the liquid container, preferably does not project by more than 1%, 2% or 5% to 10%, 20% or 50% of the overall height of the movable liquid container. Since, in embodiments according to the invention of the device, the container for the liquid, which in particular requires cleaning, is designed as a liquid container which is independent from the machine part and does not have water-sensitive components, such as electric components, said liquid container is significantly simpler and easier to clean than the containers for the liquid in conventional devices. The entire movable liquid container is cleaned together with the handle and the outside of the movable part, the outside frequently likewise becoming dirty through customary use. The device is therefore more hygienic than customary devices, not only domestically, but also when used in a large-scale business. In preferred embodiments, the entire movable part is dishwasher-safe.

A further advantage of the device according to the invention is the possibility of equipping a single machine part with a set of different liquid containers matched thereto. For example, to produce hot chocolate, a different liquid container can be placed onto the machine part than the liquid container which is suitable for producing the milk froth for, for example, two cups of cappuccino.

This invention also relates to embodiments, the machine parts of which are equipped with components by means of which the heating and/or stirring power can be regulated, adjusted and/or switched on and off or can be programmed automatically or by an operator. This is advantageous in particular if the device is also intended to be usable to produce soups, sauces, creams, puddings, mousse and the like and, for this purpose, also has a set of matching liquid containers which are easy to clean, wherein the liquid containers can differ not only in holding capacity but also in shape and material. Similarly, the set may have magnetic stirrers of differing configuration.

In another exemplary embodiment of the invention, the machine part is fitted into a coffee machine, for example, in such a manner that the supporting surface for the liquid container is arranged on the covering of the coffee machine or next to the drip surface. Simple cleaning of the movable liquid container is also of great advantage in this use of the device according to the invention. It circumvents the known problem of steam nozzles which are fitted in many commercially available coffee machines for the steam heating of milk. Said steam nozzles cannot be separated from the device for cleaning purposes and therefore frequently become stuck together or clogged up by milk residues. In contrast to the convenience of automated frothing of milk by various embodiments of the device according to the invention, the frothing of milk with a steam nozzle also requires the user to make specific movements, and to be dexterous and attentive.

Owing to the fact that, in principle, all of the embodiments of the device according to the invention can be used with different liquid containers, the range of use possibilities is considerably expanded in comparison to milk frothing devices known from the prior art and also includes the use of correspondingly configured devices in the catering trade.

### BRIEF DESCRIPTION OF THE DRAWINGS

Exemplary embodiments are described in more detail in conjunction with the figures below. However, the invention is not restricted to said embodiments. Features of various embodiments described can be combined into other advantageous embodiments. In the figures:

FIG. 1 shows a schematic section through a preferred embodiment of the device according to the invention for stirring and frothing in the state in which the indentation in the liquid container is already partially placed onto the bulge of the machine part but does not yet rest on the supporting surface of the machine part.

FIG. 2 shows a schematic section through another preferred embodiment of the device according to the invention for stirring and frothing, which device has an insulating positioning ring.

FIG. 3 shows a schematic section through another preferred embodiment of the device for stirring and frothing, in which device the magnetic stirrer is positioned in the liquid container by means of a holding bar.

### DETAILED DESCRIPTION OF THE INVENTION

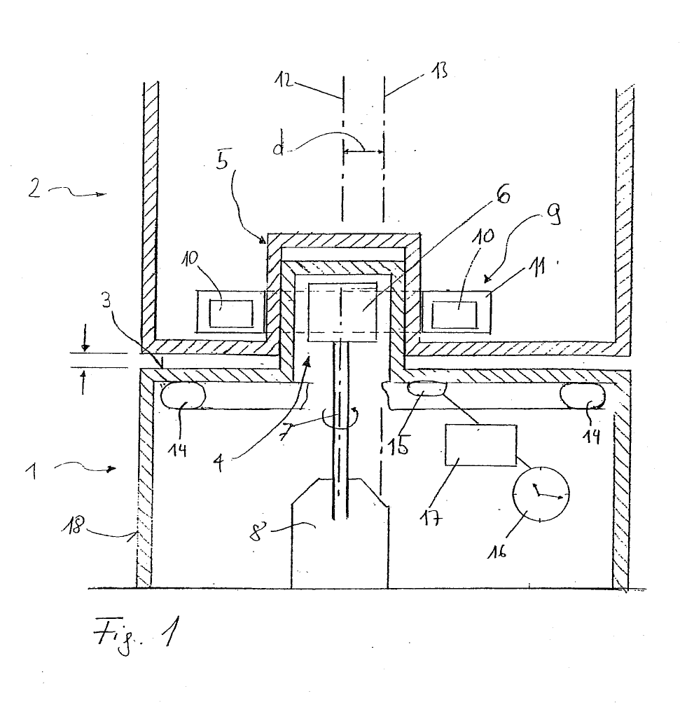

FIG. 1 shows an embodiment in which the device consisting of a machine part 1 and a liquid container 2 is assembled such that the liquid container is placed with an indentation 5 onto a bulge 4 and onto a supporting surface 3 of the machine part. The indentation and bulge have a round cross section. A motor 8 which, via a shaft 7, drives a driving magnet 6 which projects into the bulge 4 of the machine part is located in the machine part 1. A movable magnetic stirrer 9 is plugged on the indentation 5 on the base of the liquid container 2. A movable magnetic stirrer 9 of this type which is known from the prior art consists of an annular holder 11 which contains two magnets 10, diametrically. Depending on the embodiment, an annular holder of this type—or in particular the inner surface thereof—can consist of Teflon, the smooth surface of which causes little friction and brings about easy rotatability on the indentation 5 which has a circular cross section. In addition, said holder can be equipped on the periphery, for example, with a wire coil which assists the frothing in the manner of a balloon whisk. Apart from the magnetic stirring mechanism, other components, such as a heater 14, a temperature sensor 15, a timer 16 and optionally a control element 17 may also be fitted in the machine part 1.

In preferred embodiments of the invention—as illustrated in FIG. 1—a driving axis 12 of the driven magnet 6 is remote by a distance d from a center axis 13 of the liquid container, as a result of which the movable magnetic stirrer 9, placed on the indentation 5 on the base of the liquid container, is positioned eccentrically, which is advantageous in terms of mixing.

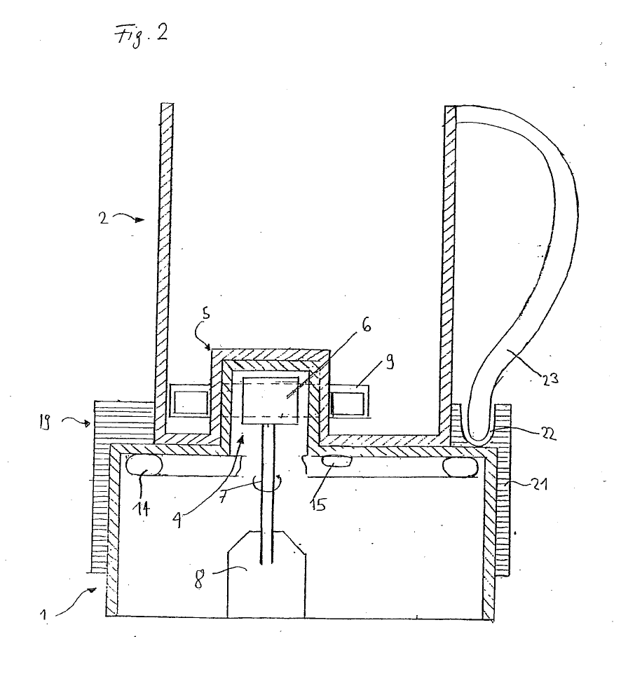

FIG. 2 shows a similar embodiment of the device according to the invention, in which the same parts are denoted by the same reference numbers. This particularly preferred embodiment is equipped with an insulating positioning ring 19 about the machine part 1. The positioning ring 19 is mounted movably or fixedly on the machine part 1 or an integral part of the housing of the machine part 1 and the edge thereof projects over the supporting surface 3. The vertical extent of the lateral surface area 20 of the positioning ring 19 may cover the entire vertical housing wall 18 of the machine part or else only a part thereof. In preferred embodiments, the positioning ring 19 does not project far over the base surface of the liquid container 2. The positioning ring 19 is equipped with an insulating region 21 on the inside of the outer wall 20 of the insulating positioning ring. The insulating positioning ring may additionally be equipped with a recess 22 into which a handle 23 of the liquid container 2 fits. This particularly advantageous embodiment of the invention protects the users from inadvertent contact with the heated supporting surface and additionally assists correct positioning of the indentation 4 of the liquid container 2 on the bulge 5 of the machine part 1.

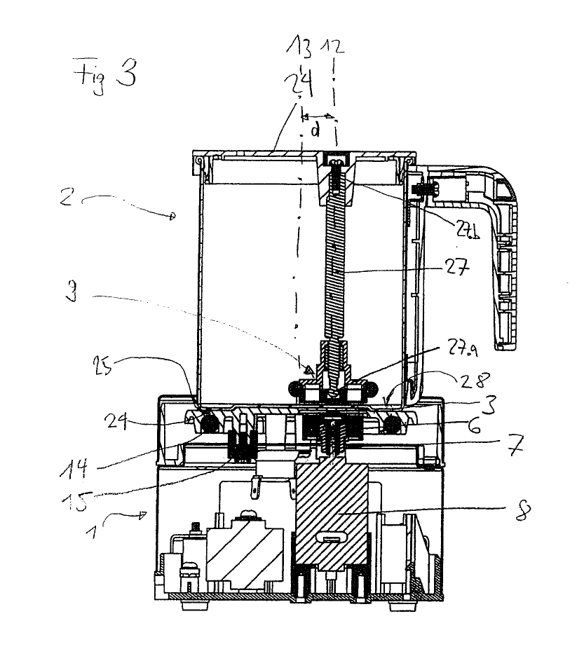

FIG. 3 shows an embodiment of the device according to the invention with a machine part 1 and a liquid container 2, in which the magnetic stirrer 9 is held rotatably by a structure 27 which can be reversibly brought into the liquid container. In preferred embodiments, said structure 27 which can be reversibly brought in is a holding bar, for example produced from stainless steel or from a suitable heat-resistant plastic. At the lower end 27.a, the holding bar is connected rotatably to the magnetic stirrer 9. In preferred embodiments, a holding bar 27 of this type or at least the outer surface thereof consists of Teflon, the smooth surface of which causes little friction and ensures easy rotatability of the magnetic stirrer 9 on the holding bar 27 which has a circular cross section. The holding bar 27 is preferably fastened at the upper end 27.b to a removable cover 24, wherein the fastening preferably ensures axial stability of the holding bar and therefore at least to a large extent prevents the lateral deviation thereof from the stirring axis. The inner base 28 of the liquid container is of a continuously flat design and is therefore very simple to clean. The outer base is equipped with, for example, annular matching structures 25 matching corresponding matching structures 24 of the supporting surface 3, as a result of which the liquid container 2 can be placed onto the machine part 1 in a precisely fitting manner and optionally also in a predetermined rotational position. In preferred embodiments, the magnetic stirrer 9 is positioned asymmetrically in the liquid container 2 such that the stirring axis 12 is remote from the center axis 13 of the liquid container 2 by a distance d. Correspondingly, for example, the cover 24 or fastening means on the upper edge of the liquid container 2 are or is also equipped with matching structures in such a manner that said matching structures are arranged in a predetermined rotational position relative to one another in the operating state. The arrangement of the matching structures ensures that the magnetic stirrer 9 is aligned above the driving magnet 6 of the machine part 1 such that the driving magnet 6 drives the magnetic stirrer 9 which is mounted rotatably in the liquid container 2. Furthermore, the motor 8 which, via the shaft 7, drives the driving magnet 6 is located in the machine part 1. Apart from the magnetic stirring mechanism, the machine part preferably also contains other components, such as, for example, a heater 14 and/or a temperature sensor 15.

### LIST OF REFERENCE NUMERALS

1. Machine part
2. Liquid container
3. Supporting surface of the machine part for the liquid container
4. Bulge of the supporting surface
5. Indentation in the base of the liquid container
6. Driving magnet
7. Shaft
8. Motor
9. Magnetic stirrer
10. Magnet of the magnetic stirrer
11. Annular holder of the magnets of the magnetic stirrer
12. Driving axis
13. Center axis of the liquid container
d Distance between the driving axis and the center axis
14. Heater
15. Temperature sensor
16. Timer
17. Control element
18. Vertical housing wall of the machine part
19. Positioning ring
20. Outer wall of the positioning ring
21. Insulating region
22. Recess
23. Handle
24. Matching structure of the supporting surface matching a corresponding matching structure on the base of the liquid container
25. Matching structure on the base of the liquid container matching a corresponding matching structure of the supporting surface
26. Cover
27. Holding bar for the magnetic stirrer with a lower end 27.a and an upper end 27.b
28. Inner base surface of the liquid container

1. A device for stirring or frothing liquid foods, comprising:
a liquid space for receiving the food, and
a magnetic stirring apparatus, a magnetic drive of which can be transmitted to a magnetic stirrer which can be positioned rotatably in the liquid space,
wherein the device has a machine part and a movable liquid container which is matched to the machine part, is independent therefrom and which provides the space for receiving the liquid food, and
wherein the movable liquid container does not contain any electric components.

2. The device as claimed in claim 1, wherein the liquid container has a structure mounted permanently in the space provided for the liquid or a structure which can be reversibly brought in, by which structure a magnetic stirrer is held and mounted rotatably in the liquid container and is positioned relative to a driving magnet in such a manner that the magnetic drive of the driving magnet in the machine part can be transmitted to the magnetic stirrer in the liquid container.

3. The device as claimed in claim 2, wherein the permanently mounted structure is present in the space provided for the liquid, wherein the machine part has a supporting surface over which the driving magnet projects, and the structure mounted permanently in the space provided for the liquid space is designed as an indentation in a base of the liquid container, the indentation being matched to the projecting driving magnet, and the magnetic stirrer being mounted in a freely rotatable manner on the indentation.

4. The device as claimed in claim 3, wherein the supporting surface has a bulge which is matched to the driving magnet and to the indentation in the liquid container.

5. The device as claimed in claim 2, wherein the structure can be reversibly brought into the space provided for the liquid, and wherein the structure which can be reversibly brought in is a holding bar for the magnetic stirrer.

6. The device as claimed in claim 5, wherein the holding bar is fastened to a cover.

7. The device as claimed in claim 2, wherein the driving magnet in the machine part and the permanently mounted structure or the structure which can be reversibly brought in into the liquid container are arranged in a correspondingly eccentric manner.

8. The device as claimed in claim 1, wherein the liquid container is equipped with at least one handle.

9. The device as claimed in claim 1, wherein the machine part additionally contains a heater for heating the supporting surface.

10. The device as claimed in claim 9, wherein the heating power or the stirring power can be regulated, adjusted or switched on and off automatically or by an operator.

11. The device as claimed in claim 1, wherein the device furthermore has a positioning ring (19) which is formed as part of the housing of the machine part or is placed or placable on the machine part.

12. The device as claimed in claim 11, wherein the positioning ring is equipped with an insulating region.

13. The device as claimed in claim 11, wherein the liquid container has a handle which engages in a recess in the positioning ring.

14. The device as claimed in claim 3, wherein the machine part is fitted into a coffee machine, the supporting surface being designed as a horizontal part of the housing of the coffee machine.

15. A liquid container for a device as claimed in claim 1, wherein said liquid container does not contain any electric components, and wherein said liquid container has a structure for a magnetic stirrer, which structure is mounted permanently in the liquid space or a structure for a magnetic stirrer, which structure can be reversibly brought in and can be fastened to a cover, and wherein said liquid container has corresponding structures for matching to the supporting surface or to a projecting driving magnet or to the bulge or to the positioning ring or to matching structures of the supporting surface of a device.
